(19) United States
(12) Patent Application Publication
(10) Pub. No.: US 2007/0290962 A1
(43) Pub. Date: Dec. 20, 2007

(54) Method and system for displaying an image

(75) Inventors: David C. Hutchison, Plano, TX (US); Steven M. Penn, Plano, TX (US); Andrew I. Russell, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/455,429

(22) Filed: Jun. 19, 2006

(51) Int. Cl. G09G 3/34

(52) U.S. Cl. 345/84

(57) ABSTRACT

According to one embodiment, a method for displaying an image in a light processing system includes receiving an image to be displayed. The method also includes generating a light from a light source. The method further includes receiving the light at a spatial light modulator having a group of pixels. The method further includes displaying the image along an optical path. The method further includes automatically defocusing the image by adjusting at least one of a group of optical elements along the optical path, thereby reducing pixel noise in the displayed image.

### TECHNICAL FIELD

This invention relates generally to visual displays, and more particularly to a method and system for displaying an image.

### BACKGROUND

Televisions and other types of displays are pervasive in today's society, as is the introduction of higher definition displays. Engineers continue to increase the resolution of displays to enhance picture quality, but also face constraints associated with providing increased resolution.

One approach for increasing the resolution of a display involves displaying a first image that includes a set number of pixels corresponding to the same number of sample data points of the image to be displayed. Then at a time period very close to the display of the first image, displaying a second image, including the same number of pixels but with slightly different sample points of the image. This second image on the display is offset by a small amount from the display of the first image. The human eye perceives both images as being displayed at the same time, resulting in an effective doubling of the display resolution. This technique is referred to in the industry by many names including modulation, optical dithering, and spatial-temporal multiplexing. Techniques such as the one described may introduce noise into the image, which can be objectionable.

### OVERVIEW OF EXAMPLE EMBODIMENTS

According to one embodiment, a method for displaying an image in a light processing system includes receiving an image to be displayed. The method also includes generating a light from a light source. The method further includes receiving the light at a spatial light modulator having a group of pixels. The method further includes displaying the image along an optical path. The method further includes automatically defocusing the image by adjusting at least one of a group of optical elements along the optical path, thereby reducing pixel noise in the displayed image.

According to another embodiment, a method for displaying an image includes receiving an image to be displayed. The method also includes displaying the image along an optical path. The method further includes automatically defocusing the image by adjusting at least one of a group of optical elements along the optical path.

Technical advantages of particular embodiments of the present invention include a system and method for displaying an image that reduces undesired noise effects resulting from increasing image resolution. Thus, reducing the undesired effects may improve the quality of the resulting image.

Another technical advantage of particular embodiments of the present invention includes a system and method for displaying an image that achieves very low grey levels by defocusing a spatial pattern. Thus, it is not necessary to reduce the illumination by using neutral-density color wheel segments or lamp pulsing.

It will be understood that the various embodiments of the present invention may include some, all, or none of the enumerated technical advantages. In addition other technical advantages of the present invention may be readily apparent to one of ordinary skill in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1 is a block diagram showing portions of a light processing system according to one embodiment of the invention; and

FIG. 2 is a flowchart illustrating an example method for displaying an image according to one embodiment of the invention.

### DETAILED DESCRIPTION OF EXAMPLE EMBODIMENTS

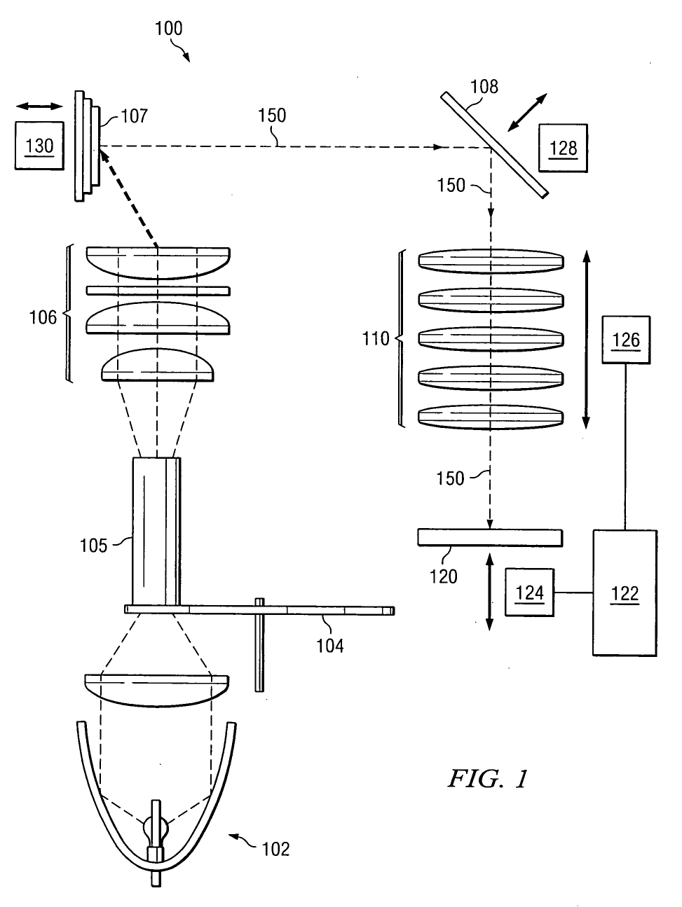

FIG. 1 illustrates one embodiment of a light processing system 100 according to the teachings of the present invention. As shown in FIG. 1, light processing system 100 generally includes a light source 102, a color wheel 104, an integration rod 105, and a prism assembly 106. System 100 further includes a spatial light modulator 107, a fold mirror 108, a projection lens 110, and a display surface 120. The system is particularly adapted for the display of images via a spatial light modulator 107 that reflects or refracts selective portions of light emanating from light source 102 to display an image by a group of pixels that are then reflected by fold mirror 108 and projected by projection lens 110 for display on display surface 120.

Light source 102 may be any light generating element capable of generating a radiant energy beam in the visual light spectrum. Examples of such light generating elements suitable for this type of purpose include light emitting diodes (LEDs), incandescent lighting, sodium vapor, metal halide, Xenon, high-pressure mercury, fluorescent, tungsten-halogen lamps, and the like.

In addition to their relatively narrow spectral pattern, LEDs provide other advantages over other previously mentioned light generating sources. For example, LEDs are generally smaller in physical size then other light generating sources therefore providing for packaging of system 100 in a relatively smaller size. LEDs operate according to basic solid-state device principles thereby allowing for operation over a wide temperature range as well as abating the need for warm-up prior to use.

According to one embodiment of the invention, the light beam passes through color wheel 104 before entering integration rod 105. For light generating elements, color wheel 104 or other similar type element may be used to generate the group of individual color components to be used with the system. Color wheel 104 may be any device capable of modulating one of the primary colors (e.g., red, green, and blue), in the path of the illumination light beam. For example, color wheel 104 may be a scrolling color wheel or other type of recycling color wheel. Color wheel 104 enables the illumination light beam to be filtered so as to provide field sequential images. Color wheel 104 enables system 100 to generate a sequence of differently colored images that are perceived by a viewer through projection lens 110 as a correctly colored image. In various embodiments, integration rod 105 and prism assembly 106 may be any device capable of receiving and focusing the light beam onto spatial light modulator 107.

According to one embodiment of the invention, spatial light modulator 107 may have a plurality of reflective elements corresponding to the arrangement and quantity of pixels to be displayed in the image. In various embodiments, spatial light modulator 107 may be a liquid crystal display or a liquid crystal on silicon display. One device particularly suited to provide such an arrangement and quantity of reflective pixilated reflective surfaces is a digital multi-mirror device (DMD) available from Texas Instruments Inc.

The image from spatial light modulator 107 is displayed along the optical path 150 to fold mirror 108, which reflects the image so as to be directed through projection lens 110 onto display surface 120. In the illustrated embodiment, although fold mirror 108 and display surface 120 are shown diagrammatically in FIG. 1 as planar components, each may have a relatively complex curvature. The curvature may also provide some optical power.

In various embodiments, system 100 can include or implement one or more dithering techniques, such as, for example, Blue-Noise Spatial-Temporal Multiplexing, to increase the effective bit-depth of the projection display system. Blue-Noise Spatial-Temporal Multiplexing refers to a technique where a spatial light modulator 107 divides an image into multiple portions each having a blue-noise dither pattern (also referred to as high frequency noise dither pattern). The multiple portions are shown in rapid succession within a frame time to show a complete image. Because one dither pattern is shown at a time and the patterns are shown in rapid succession, the perceived resolution of an image may be increased without increasing the actual array size. An image resulting from using dithering may have unintended noise, which, depending on the situation, may lower the perceived quality of the image.

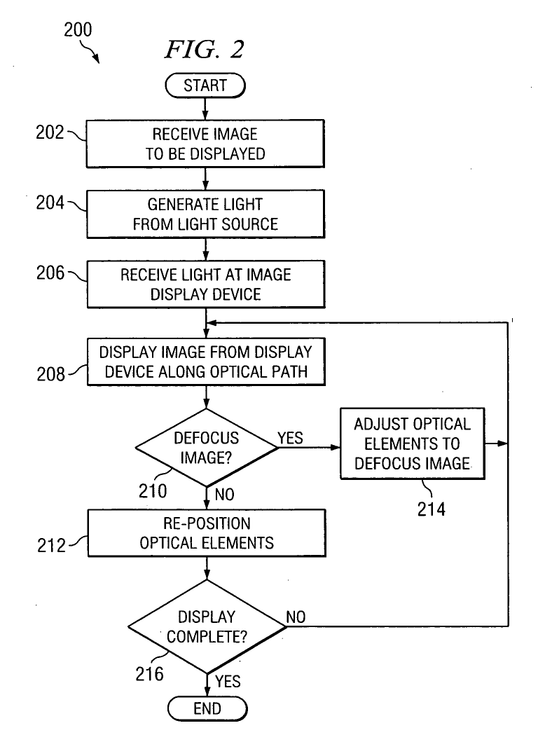

According to one embodiment of the invention, a system and method are provided that improve the quality of image shown using dithering by synchronizing the dithering with mechanical alteration of the optical path, which allows control over the noise of an image shown in a frame time. This is effected by defocusing pixels of the image where the pixel intensity is at its lowest. In one embodiment, gaps between pixels are reduced, which improves the quality of the perceived image. Additional details of example embodiments of the invention are described in greater detail below in conjunction with portions of FIG. 1 and FIG. 2.

System 100 further includes a controller 122 and actuators 124, 126, 128, and 130. Actuators 124, 126, 128, and 130 operate to automatically defocus the image by adjusting one of the optical elements 107, 108, 110, and 120 along optical path 150. Adjusting an optical element along optical path 150 adjusts the optical path length, and brings an optical element in and out of the focal plane. The focal plane is the plane along which the image is brought to a sharp focus. When an optical element is out of the focal plane, the image is defocused. For example, actuator 124 operates to selectively displace display surface 120 in and out of the focal plane. Display surface 120 may also be translated or deformed to accomplish the same effect.

Controller 122 operates to receive image data that indicates the intensity level of the pixels. For example, controller 122 may receive image data that indicates that the low intensity pixels of spatial light modulator 107 should be defocused, or that other pixel elements should be sharpened to reduce noise in the projection image. Controller 122 then instructs one or more of actuators 124, 126, 128, and 130 to adjust one or more of optical elements 107, 108, 110, and 120 to achieve the desired visual effect.

For example, controller 122 would excite actuator 124, which would then adjust display surface 120 to achieve the desired visual effect. As another example, actuator 126 operates to selectively displace projection lens 110 in and out of the focal plane. Also, actuator 126 may shape a lens element of projection lens 110 to accomplish the same effect. In a particular embodiment, shaping projection lens 110 may include shaping a liquid projection lens available from Varioptic SA. As another example, actuator 128 operates to displace fold mirror 108 into and out of the focal plane. In addition, actuator 128 may shape fold mirror 108 to place the image from spatial light modulator 107 into and out of the focal plane. As another example, actuator 130 operates to displace spatial light modulator 107 into and out of the focal plane.

In various embodiments, controller 122 may take any suitable form, and may be programmed to selectively excite actuators 124, 126, 128, and 130 adjusting the optical elements 107, 108, 110, and 120. Controller 122 may operate to control each actuator individually. That is, controller 122 may operate to control the state of actuator 124 independently of actuator 126. In other embodiments, controller 122 of system 100 can operate to collectively control all actuators 124, 126, 128, and 130. That is, controller 122 can operate to adjust all of actuators 124, 126, 128, and 130 to the same state. Although multiple actuators are shown, various embodiments of the present invention may have all, some, or none of the actuators shown. In other embodiments, controller 122 may be omitted and actuators may receive data directly.

According to one embodiment of the invention, actuators 124, 126, 128, and 130 defocus the image at a periodic frame rate. The waveform properties used to excite actuators 124, 126, 128, and 130 define the Modulation Transfer Function of system 100. The Modulation Transfer Function relates to the spatial roll off frequency of a single pixel exposed to an ideal point source of infrared radiation. If the difference between adjacent pixels is greater than what would be expected from a single point source, then one of pixels is characterized as defective. The Modulation Transfer Function is a performance indicator to measure contrast and spatial frequency. For example, the periodic excitation function used to defocus the image can be a square wave function, a ramp function, or a multiple ordered sinusoidal function.

FIG. 2 is a flow chart of a method for displaying an image along an optical path. At step 202, the image display system receives the image data. In particular embodiments, image data may be received from a communications device and may include image content, color content, integrated intensity of the image frame, a peak to peak intensity value of the image frame, and/or a subjectively weighted area, such as the center of the image. Image data may be used by the controller to determine intensity levels of the pixels within the image.

At step 204, the light source generates light along the optical path. In particular embodiments, the light beam may include projection light emitted from the light source. The projection light may be transmitted through optical elements of the display system.

At step 206, the light beam is received at spatial light modulator. In particular embodiments, spatial light modulator may include a device selected from a group consisting of a digital micro-mirror device, a liquid crystal display device, and a liquid crystal on silicon display device. At step 208, the spatial light modulator may transmit an image along the optical path by a group of pixels to a fold mirror, then to a projection lens. The projection lens then displays the image onto a display surface.

At step 210, a determination may be made as to whether new image data is received and whether the image should be defocused. Where such image data is received, a new target position for optical elements may be determined based at least in part on the new image data received at step 210. In particular embodiments, new image data may be received on a frame-by-frame basis. In other embodiments, new image data may be received on a multiple frames-by-multiple frames basis.

A determination may be made to defocus the new image at step 210. Once one of a plurality of optical elements is adjusted to defocus the image at step 214, the method may return to step 208 where the image is displayed along the optical path. Alternatively, where the new image should not be defocused, the optical elements are re-positioned to sharpen the image at step 212. Following the re-positioning of optical elements, the method may return to step 208 where the image is displayed along the optical path. The method may continue by cycling through steps 208 to 216 until, new image data is not received, at which time the method terminates.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for displaying an image in a light processing system comprising:
receiving an image to be displayed;
generating light from a light source;
receiving the light at a spatial light modulator having a plurality of pixels;
displaying the image by the spatial light modulator along an optical path; and
automatically defocusing the image by adjusting at least one of a plurality of optical elements along the optical path, thereby reducing any pixel noise in the displayed image.

2. The method of claim 1, wherein generating a light from a light source comprises generating light from a light-emitting diode.

3. The method of claim 1, wherein displaying the image from the spatial light modulator comprises dithering the image.

4. The method of claim 1, wherein the spatial light modulator comprises a device selected from the group consisting of:
a liquid crystal display device;
a liquid crystal on silicon display device; and
a digital micromirror device.

5. The method of claim 1, wherein one of a plurality of optical elements comprises a liquid projection lens.

6. The method of claim 1, wherein adjusting one of a plurality of optical elements along the optical path further comprises an act selected from the following group consisting of:
displacing a projection lens;
displacing a fold mirror;
displacing the spatial light modulator;
shaping the projection lens;
shaping the fold mirror;
translating a display surface; and
displacing the display surface.

7. The method of claim 1, wherein adjusting one of a plurality of optical elements along the optical path comprises receiving image data indicative of intensity levels for pixels to be displayed, and further comprises defocusing the image in response to the low intensity pixels.

8. The method of claim 1, wherein adjusting one of a plurality of optical elements along the optical path comprises adjusting one of a plurality of optical elements at a periodic frame rate.

9. The method of claim 1, wherein adjusting one of a plurality of optical elements along the optical path comprises calculating an excitation function based on one of a square wave function, a ramp function, and a multiple ordered sinusoidal function.

10. A system for displaying an image in a light processing system comprising:
a light source operable to generate light;
a spatial light modulator operable to receive the light and display an image along an optical path by a plurality of pixels; and
a plurality of optical elements operable to direct the image along the optical path;
an actuator operable to automatically defocus the image by adjusting one of the plurality of optical elements along the optical path, thereby reducing any pixel noise in the displayed image.

11. The system of claim 10, wherein the spatial light modulator is operable to dither the image.

12. The system of claim 10, wherein the spatial light modulator comprises a device selected from the group consisting of:
a liquid crystal display device;
a liquid crystal on silicon display device; and
a digital micromirror device.

13. The system of claim 10, wherein one of a plurality of optical elements comprises a liquid projection lens.

14. The system of claim 10, wherein the actuator is operable to adjust one of a plurality of optical elements along the optical path by an act selected from the group consisting of:
displacing a projection lens;
displacing a fold mirror;
displacing the spatial light modulator;
shaping the projection lens;
shaping the fold mirror;
translating a display surface; and
displacing the display surface.

15. The system of claim 10, and further comprising a controller operable to receive image data indicative of intensity levels for pixels to be displayed and provide a signal to the actuator to defocus the image in response to the low intensity pixels.

16. The system of claim 10, wherein the actuator is operable to adjust one of a plurality of optical elements along the optical path at a periodic frame rate.

17. The system of claim 10, wherein the actuator is operable to adjust one of a plurality of optical elements along the optical path according to an excitation function based on one of a square wave function, a ramp function, and a multiple ordered sinusoidal function.

18. A method for displaying an image comprising:
receiving an image to be displayed;
displaying the image along an optical path; and
automatically defocusing the image by adjusting at least one of a plurality of optical elements along the optical path.

19. The method of claim 18, wherein adjusting at least one of a plurality of optical elements along the optical path comprises adjusting a position of at least one of a plurality of optical elements along the optical path.

20. The method of claim 18, wherein adjusting one of a plurality of optical elements along the optical path further comprises an act selected from the following group consisting of:
displacing a projection lens;
displacing a fold mirror;
displacing the spatial light modulator;
shaping the projection lens;
shaping the fold mirror;
translating a display surface; and
displacing the display surface.
